(19) United States
(12) Patent Application Publication
(10) Pub. No.: US 2012/0116772 A1
(43) Pub. Date: May 10, 2012

(54) Method and System for Providing Speech Therapy Outside of Clinic

(75) Inventors: Kevin Jones, Gainesville, FL (US); Garima Srivastava, Sunrise, FL (US)

(73) Assignee: AventuSoft, LLC, Sunrise, FL (US)

(21) Appl. No.: 13/293,092

(22) Filed: Nov. 9, 2011

Related U.S. Application Data
(60) Provisional application No. 61/456,671, filed on Nov. 10, 2010.

(51) Int. Cl. G10L 11/00

(52) U.S. Cl. 704/270; 704/E11.001

(57) ABSTRACT

A system and method for speech therapy is provided that includes a mobile device, a server and a web-client. The mobile device captures and processes voice signals analyzed locally and on the server and from which a speech therapy is coordinated and delivered. The web-client through interaction with the mobile device and through the server implements a speech therapy that can be monitored and managed thereon through specified clinical moderation. The web-client also provides an alternative method to capture and transmit voice signals to the server for analysis and from which a speech therapy is coordinated and delivered. Speech therapy management can implement therapy procedures, guidelines and one-to-one communication sessions between users and providers in a non-clinical setting in real-time or at scheduled times. Other embodiments are disclosed.

### CROSS REFERENCE TO RELATED APPLICATION

This application also claims priority benefit to Provisional Patent Application No. 61/456,671 filed on Nov. 10, 2010, the entire contents of which are hereby incorporated by reference.

### FIELD OF THE INVENTION

The embodiments herein relate generally to speech language therapy and more particularly to voice processing systems on mobile devices.

### BACKGROUND

Communication disorders are one of the most prevalent disabilities in the United States. Communication disorders are sub-classified into speech and language disorders, with speech disorders further classified as fluency disorders, voice disorders, motor speech disorders, and speech sound disorders. Stuttering for example is a Fluency disorder in the rhythm of speech in which an individual knows precisely what he wishes to say, but at the time is unable to speak. Therapy provided by a Speech Language Pathologist (SLP) in their clinics (clinical therapy) is the primary treatment for long term improvement, but no device or system are known that can provide it in realworld situations outside of clinics. SLP's are handicapped by not having such a solution because they know treating a speech disorder in a clinical setting is completely different from treating stutter in real world situations.

Conventional techniques of clinical therapy provided by an SLP in their clinic or via tele-therapy, clinical therapy via intensive speech therapy programs, or clinical therapy via user groups, are some of the options available to a person in need (PIN). However, in all conventional approaches, the attempt to treat stuttering is known to occur in a clinic setting.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1A illustrates a system for providing speech therapy over a network in accordance with one embodiment;

FIG. 1B illustrates a network for delivering speech therapy in accordance in accordance with one embodiment;

FIG. 2 illustrates a mobile device for providing speech therapy in accordance with one embodiment;

FIG. 3 illustrates a Graphical User Interface for providing speech therapy in accordance with one embodiment;

FIG. 4 presents a method for providing, monitoring and managing speech therapy over a network in accordance with one embodiment;

FIG. 5A illustrates a chart for mapping perceptual evaluation with objective values of voice disorders in accordance with one embodiment;

FIG. 5B illustrates a table of speech features measured herein in accordance with one embodiment;

FIG. 6 diagrammatically illustrates a means of implementing speech therapy on a mobile device in accordance in accordance with one embodiment;

FIG. 7 diagrammatically illustrates a means of implementing speech therapy by way of a server in accordance in accordance with one embodiment; and

FIG. 8 diagrammatically illustrates a means of implementing speech therapy by way of a web-client in accordance in accordance with one embodiment.

### DETAILED DESCRIPTION

Herein disclosed is a method and system for providing speech therapy outside of a clinical setting. The method and system combines practices of clinical therapy with psychoacoustic voice analysis to to assess and administer clinical therapy directly in real-world situations via a mobile platform. The method and system provide a direct extension of clinical therapy in real-life situations for sustained long term improvement, and to provide a trained clinician, or Speech Language Pathologist, capabilities of monitoring, assessing and treating speech disorders by way of a web-client, server and mobile device platform, which can include stuttering and other speech disorder experiences outside of clinics.

In a first embodiment, a method for providing speech therapy comprises, on a mobile device, capturing a voice signal, extracting speech features from the voice signal, performing an automated measurement of the speech features and the voice signal, transmitting the automated measurement and voice signal from the mobile device to a server communicatively coupled to a web-client to compute a speech therapy assessment from that data, respond with a speech therapy technique according to a specified clinical moderation, and manage and implement the speech therapy technique and training on the mobile device. The method can include transmitting the automated measurement to the web client that by way of clinical interaction that remotely monitors and manages delivery and clinical feedback of the therapy technique on the mobile device.

In a second embodiment, a mobile device client, comprises a processor to capture and record from one or more microphones a voice signal, extract speech features from the voice signal, perform an automated measurement of the speech features and the voice signal, and perform automated assessment from that data to respond with a analysis feedback for the user, a memory to temporarily store the speech features, voice signal, automated measurement and automated assessment, and a communications unit to transmit the automated measurement and voice signal from the mobile device to a server that computes a speech therapy assessment from that data, responds with a speech therapy technique according to a specified clinical moderation, and transmits and implements the speech therapy technique on the mobile device. The mobile device can thereafter provide speech feature correction to the voice signal, display the speech therapy assessment, and provide for speech compensation training on the mobile device in accordance with the speech therapy technique.

In a third embodiment, a system for providing speech therapy, comprises a mobile device including a processor to capture and record from one or more microphones a voice signal, extract speech features from the voice signal, perform an automated measurement of the speech features and the voice signal, and perform automated assessment from that data to respond with a analysis feedback for the user, a memory to temporarily store the speech features and voice signal and automated measurement. and a communications unit to transmit the automated measurement and voice signal from the mobile device. A server communicatively coupled to a web-client as part of the system computes a speech therapy assessment from the automated measurement and voice signal received from the mobile device, responds with a speech therapy technique according to specified clinical instructions, and transmits and manages an implementation and outcome of the speech therapy technique by way of the mobile device.

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely. The term “processing” can be defined as number of suitable processors, controllers, units, or the like that carry out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

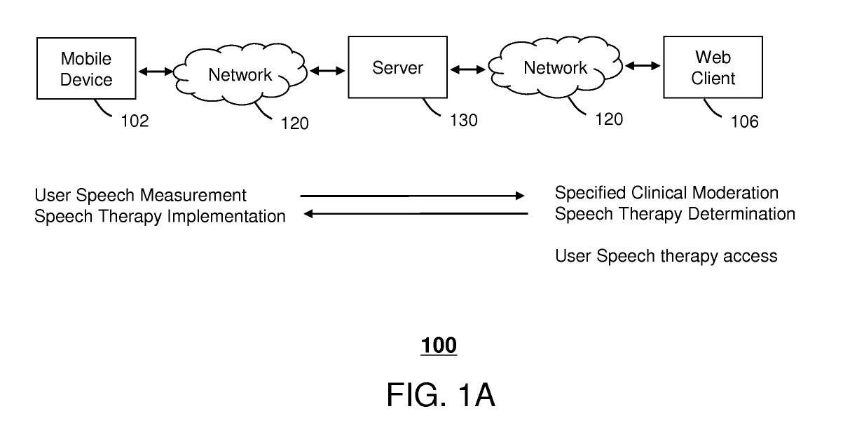

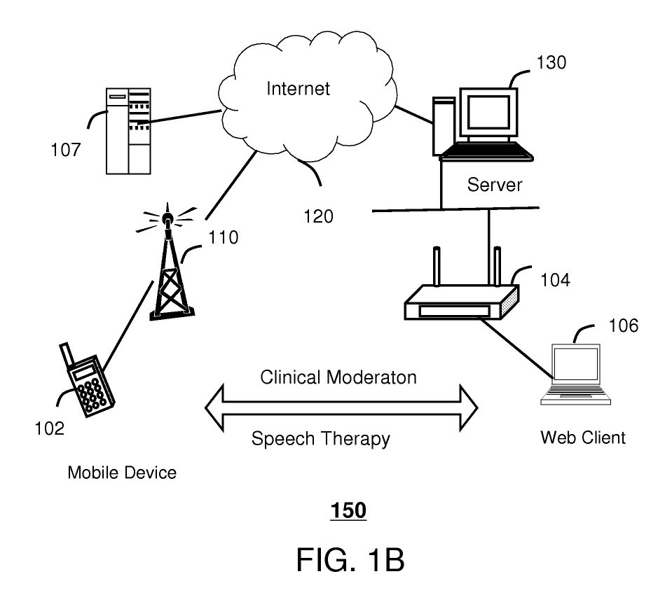

Referring to FIG. 1A, a system 100 for providing speech therapy is shown. The system 100 comprises a mobile device 102, a server 130 and a web client 106. A network component 120 provides communication between the mobile device 102, server 130 and web client 106. The exemplary embodiments herein as illustrated provide a system and method for evaluating a speech disorder measurement, including fluency disorders, voice disorders, motor speech disorders, speech sound disorders, pronunciation, accent and articulation problems, and assessment and life-style treatment for providing clinical therapy outside a clinical setting by way of the mobile device 102, networked server 130 and web client 106.

The system 100 provides for the capture of voice signals and user speech measurement on the mobile device 102. This information is transmitted to the server 130 for additional comprehensive speech evaluation. The server 130 performs the additional measurements and assessments on captured speech signals, and then renders and provides this information to a web client 104. Although the web-client is configured to provide a determination of speech therapy, the server 130 in certain roles can be delegated to evaluate speech measurements and make a determination of speech therapy responsive to instructions and directions from the web client 106. The web client 106 in general configures and presents the measurements outside a clinical setting for moderation and speech therapy determination. As an example, a speech language therapist or pathologist registers with the system 100 and interacts with the web client 106 to evaluate a user's speech disorder characteristics and to provide speech therapy in a non-clinical setting. By way of the web client 106, the speech language therapist through on-line access can direct a speech therapy technique derived in view of the presented assessments to the mobile device 102 which thereafter implements the speech therapy technique thereon.

The web-client 106 can communicate with the mobile device 102 over an internet cloud through the network 120 and securely with server 130. A graphical user interface of the web-client can be provided via an internet browser. The User interface of the web-client provides user login, new user registration, and user account capabilities. It can display and review captured measurement data captured in various real-life situations, and can be accessed by a Speech Language Pathologis for numerous user clients (e.g., persons in need (PIN) registered there under or by an individual PIN to review their own data.

As one exemplary User Interface application, a therapy management module implemented on the web-client allows a Speech Language Pathologist (SLP) to monitor, manage and modify particular therapy techniques for individuals with speaking disorders, for instance, a person in need (PIN) from measurements made on the server 130 and provided to the web client 106. The web client 106 module interacts with the user and update information on the mobile device related to the user speech experience, for example, the effort level of speaking, in what way they are following speaking guidelines, how they are interacting with background noise or environmental sounds, and how they are articulating, voicing, and phrasing their spoken utterances and other real life experiences. This information can include assessment of new therapy procedures, guidelines, information or one-to-one communication between SLP and PIN, which can be in real-time when both SLP and PIN are connected at the same time. The PIN profile management that can be used by SLP and by individual PIN. This module also provides for capturing audio via the web-client, and audio data communications sent to the server 130 for processing.

Referring to FIG. 1B, a mobile communication environment 100 is shown. The mobile communication environment 100 can provide wireless connectivity over a radio frequency (RF) communication network, a Wireless Local Area Network (WLAN) or other telecom, circuit switched, packet switched, message based or network communication system. In one arrangement, the mobile device 102 can communicate with a base receiver 110 using a standard communication protocol such as CDMA, GSM, TDMA, etc. The base receiver 110, in turn, can connect the mobile device 102 to the Internet 120 over a packet switched link. The internet can support application services and service layers 150 for providing media or content to the mobile device 102. The mobile device 102 can also connect to other communication devices through the Internet 120 using a wireless communication channel. The mobile device 102 can establish connections with a server 130 on the network and with other mobile devices for exchanging information. The server 130 can have access to a database 140 that is stored locally or remotely and which can contain profile data. The server can also host application services directly, or over the internet 150. In one arrangement, the server 130 can be an information server for entering and retrieving presence data.

The mobile device 102 can also connect to the Internet over a WLAN 104. Wireless Local Access Networks (WLANs) provide wireless access to the mobile communication environment 100 within a local geographical area 105. WLANs can also complement loading on a cellular system, so as to increase capacity. WLANs are typically composed of a cluster of Access Points (APs) 104 also known as base stations. The mobile communication device 102 can communicate with other WLAN stations such as a laptop 103 within the base station area 105. In typical WLAN implementations, the physical layer uses a variety of technologies such as 802.11b or 802.11g WLAN technologies. The physical layer may use infrared, frequency hopping spread spectrum in the 2.4 GHz Band, or direct sequence spread spectrum in the 2.4 GHz Band. The mobile device 102 can send and receive data to the server 130 or other remote servers on the mobile communication environment 100. In one example, the mobile device 102 can send and receive images from the database 140 through the server 130.

Within the mobile device 102, a plurality of computation modules receive the speaker's raw audio by way of the microphones and perform source separation, noise removal, end-point detection, automated measurements, automated assessment and record the speaker's voice on the mobile device 102 (platform). A plurality of second computation modules store the audio data and transmit that data to the server 130 for measurements on the server 130. A plurality of third computation modules on the server 130 provide training and practice capabilities for users (e.g., persons in need) to practice various therapy techniques on the mobile device 102. A plurality of fourth computation modules through the web client 106 provide the speech language pathologist with capabilities to receive data and provide speech therapy feedback. The web client 106 can be accessed on-line through an internet connection, a mobile device, or other mobile platform communicatively coupled to the server over the network 120. A plurality of fifth computation modules on the server 130 separately, or in combination with the mobile device 102, processes audio data for measurements, assessment, storage and client profile management.

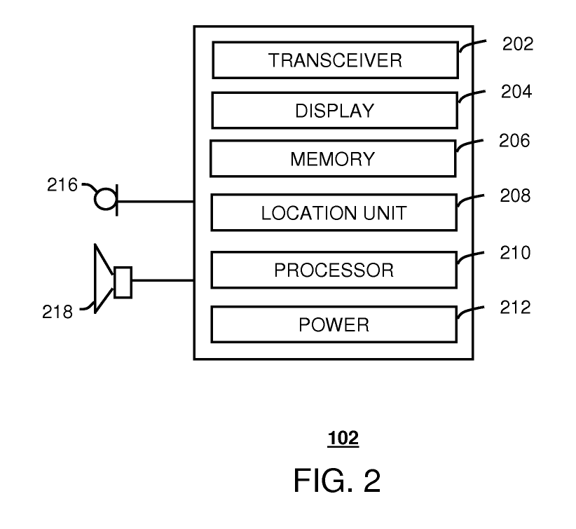

FIG. 2 depicts an exemplary embodiment of the mobile device 102. It can comprise a wired and/or wireless transceiver 202, a user interface (UI) display 204, a memory 206, a location unit 208, and a processor 206 for managing operations thereof. The mobile device 102 can be a cell phone, a laptop, a notebook, a tablet, or any other type of portable and mobile communication device. A power supply 212 provides energy for electronic components. The mobile device 102 also includes a microphone 216 for capturing voice signals and environmental sounds and a speaker 218 for playing audio or other sound media. One or more microphones may be present for enhanced noise suppression such as adaptive beam canceling, and one or more speakers 218 may be present for stereophonic sound reproduction.

In one embodiment where the mobile device 102 operates in a landline environment, the transceiver 202 can utilize common wire-line access technology to support POTS or VoIP services. In a wireless communications setting, the transceiver 202 can utilize common technologies to support singly or in combination any number of wireless access technologies including without limitation cordless phone technology (e.g., DECT), Bluetooth™ Wireless Fidelity (WiFi), Worldwide Interoperability for Microwave Access (WiMAX), Ultra Wide Band (UWB), software defined radio (SDR), and cellular access technologies such as CDMA-1X, W-CDMA/HSDPA, GSM/GPRS, TDMA/EDGE, and EVDO. SDR can be utilized for accessing a public or private communication spectrum according to any number of communication protocols that can be dynamically downloaded over-the-air to the communication device. It should be noted also that next generation wireless access technologies can be applied to the present disclosure.

The power supply 214 can utilize common power management technologies such as replaceable batteries, supply regulation technologies, and charging system technologies for supplying energy to the components of the communication device and to facilitate portable applications. In stationary applications, the power supply 214 can be modified so as to extract energy from a common wall outlet and thereby supply DC power to the components of the communication device 106.

The location unit 208 can utilize common technology such as a GPS (Global Positioning System) receiver that can intercept satellite signals and therefrom determine a location fix of the mobile device 102.

The controller processor 210 can utilize computing technologies such as a microprocessor and/or digital signal processor (DSP) with associated storage memory such a Flash, ROM, RAM, SRAM, DRAM or other like technologies for controlling operations of the aforementioned components of the communication device.

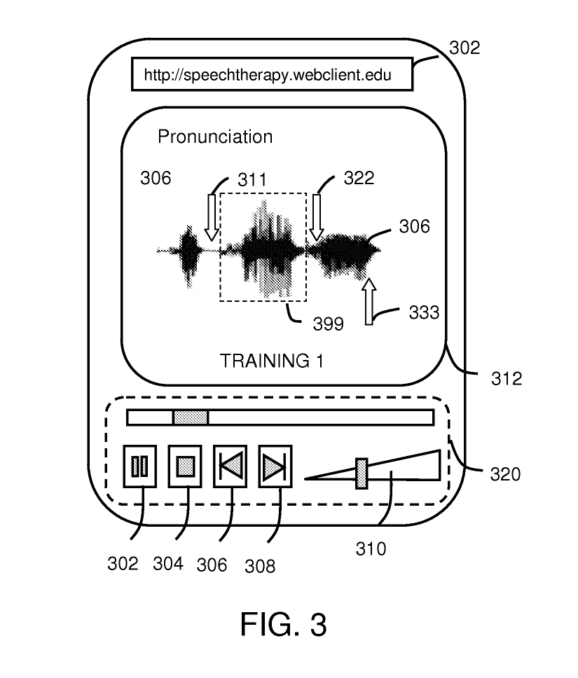

Referring to FIG. 3, an exemplary user interface 200 of the mobile device 102 is shown. As illustrated the user interface can include a keypad 320 with depressible or touch sensitive navigation disk and keys for manipulating audio operations of the mobile device 102 (e.g., 302—pause, 304—stop, 306—forward, 308—rewind). The UI 204 can further include a display 312 such as color LCD (Liquid Crystal Display) for conveying images to the end user of the mobile device, and an audio system that utilizes common audio technology for conveying and presenting audible signals of the end user.

The display 312 provides the interactive platform that in various embodiments implements and delivers the speech therapy. As an example, the mobile device 102 upon receiving a directive from the web client 106 to implement a speech therapy technique for improving pronunciation 306 can display words to be spoken and assist the user with proper pronunciation according to the speech therapy technique. Visual cues or labels (311, 333 and 322) can be overlaid to assist the user with pronunciation at certain key times during the word pronunciation. As another example, certain speech sections 399 can be identified, emphasized, or isolated during pronunciation. The display can serve to show captured user speech and test speech samples, or a combination thereof. For example, a test utterance can be visually overlaid to a captured user voice segment. The address link 302 can provide network connection to a database of audio data (e.g., speech sounds, words, sentences, phrases) for which the user can practice.

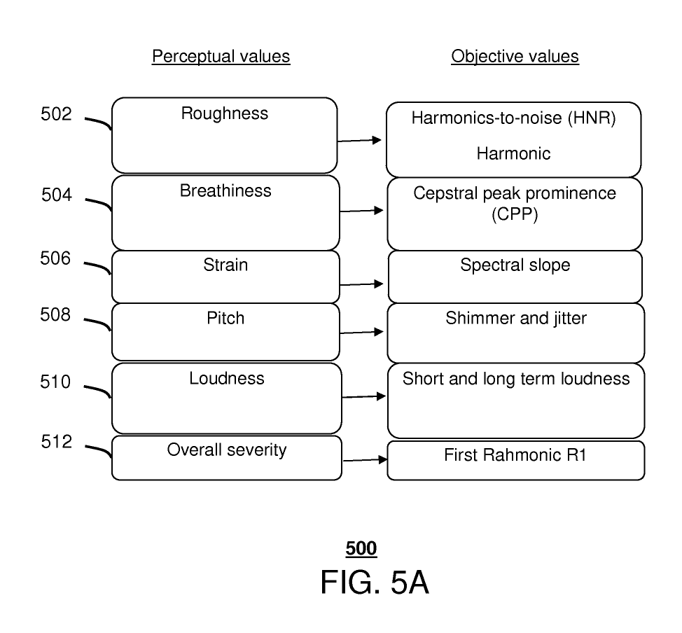

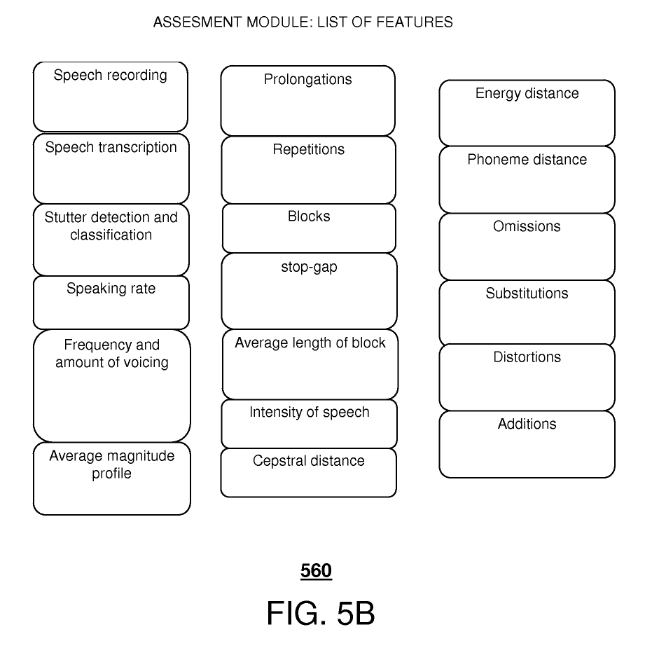

In practice, the mobile device 102 by way of the GUI 204 will prompt the user through various speech therapies according to specified clinical moderation and speech therapy determination as prescribed above. As one example of a speech therapy, the GUI 204 will present a set of spoken utterances and sentences and prompt the user speak the utterances as though they are in a real conversation. This includes effects of environmental sounds common in an outdoor setting, such as background noise, that may contribute to rising levels of vocalization, such as the Lombard effect, or personal articulations characteristic to the speaking conditions. The mobile device microphone captures and records the user's speech samples any selectively environmental sounds. After the set of recordings are taken, voice processing is performed to generate an output, for instance, in a preferred embodiment consisting of the six dimensions of perceptual evaluation for each frame of the speech signal, and the multiple dimensions discussed ahead in FIG. 5B.

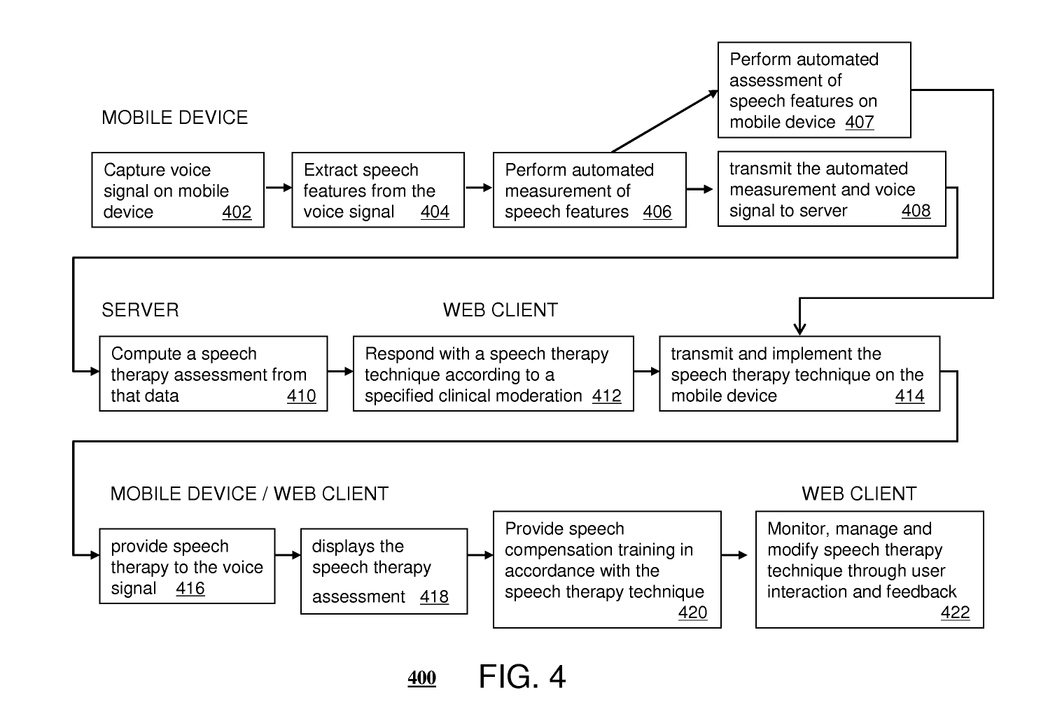

Referring to FIG. 4, a method for speech therapy is provided. The method 400 can be provided with more or less than the number of steps shown. When describing the method 400, reference will be made to FIGS. 1 to 4, although it must be noted that the method 400 can be practiced in any other suitable system or device. The steps of the method 400 are not limited to the particular order in which they are presented in FIG. 4. The method can also have a greater number of steps or a fewer number of steps than those shown in FIG. 4.

The method 400 can start in a state where a user is operating the mobile device 102. At step 402 a voice signal is captured on the mobile device. This can be achieved by way of the microphones which in one embodiment digitally sample analog voice signals. At step 404, the mobile device by way of the processor extracts speech features from the voice signal. The speech features include speaking rate, voicing, magnitude profile, intensity and loudness, pitch, pitch strength, and phonemes. Speech features may further include, but are not limited to, spectral features such as Fourier transforms, cepstral features, Linear Predictive Coding features, autocorrelation features, and time domain features, such as temporal envelope, modulation rate, onsets, decay, etc. The features can be extracted on a frame by frame basis, for example, every 20 ms, where the processing is performed directly on the audio frame. Overlap methods can also be employed for feature extraction.

A feature vector set can be considered a compressed representation of a short-time frame of speech. In practice, speech can be broken down into many short-time frames generally between 5-20 ms in length with sampling frequencies between 8-44.1 KHz. Each short-time frame of speech can be represented by a feature vector. The feature vector can be a set of Linear Prediction Coefficients (LPC), Cepstral Coefficients, Fast Fourier Transform Coefficients (FFT), Log-Area Ratio (PARCOR) coefficients, or any other set of speech related coefficients though are not herein limited to these. Certain coefficient sets are more robust to noise, dynamic range, precision, and scaling. Notably, cepstral coefficients are known to be good candidates for speech processing and recognition features. For example, the lower index cepstral coefficients describe filter coefficients associated with the spectral envelope. Higher index cepstral coefficients represent the spectral fine structure such as the pitch which can be seen as a periodic component.

Briefly, the exemplary embodiments provide a novel approach for providing clinical therapy in real-life situations. Specifically, the audio separation can be performed on the user's voice signal as a function of user's speech patterns and knowledge of psychoacoustics as a means of separating out articulatory gestures affecting speech disorder. Using this further information, conventional issues can be bypassed allowing measurements to be carried out from real-life audio data. Conventional noise cancellation techniques also include other issues when noise data is mistaken for speech data and the conversion results in a bad audio stream. The use of user's speech pattern and novel psychoacoustics avoid these issues altogether.

During this time, noise reduction techniques or background estimate techniques can be applied to acquire other signal parameter estimates, used in view of the user's voice, to assess voicing efforts, disorders and pronunciation styles. As one example, the mobile device 102 estimates noise signal and vocal pattern statistics within the captured voice signal and suppresses the noise signals according to a mapping there between. In one embodiment, this may be based on a machine learning of the spatio-temporal speech patterns of the psychoacoustic models. The machine learning may be further implemented or supported through the server 130 by way of pattern recognition systems, including but not limited to, Neural Networks, Hidden Markov Models, and Gaussian Mixture Models.

Upon speech feature extraction, as shown at step 406, the processor performs an automated measurement of the extracted speech features. The automated assessment includes measuring changes in roughness, loudness, overall severity, pitch, speaking rate, spectral analysis for voicing, and statistical modeling for determining pronunciation, accent, articulation, breathiness, strain, and applying speech correction. The measurement can include calculation of harmonic to noise values (HNR), cepstral peak prominence (CPP), spectral slope, shimmer and jitter, short and long term loudness, and rahmonic determinations. The automated measurements comprise stop-gaps, repetitions, prolongations, onsets, and mean-duration.

At step 407, the processor performs an automated assessment of these speech features on the mobile device. The assessment can include the mapping of the objective values above to perceptual values, or changes thereof, such as roughness, breathiness, strain, pitch, loudness and severity, as will be explained ahead in FIG. 5A. This involved mapping includes the application of psychoacoustic techniques that can be used to identify speech disorders and help in compensating perceived speech disorders. Returning back to FIG. 4A, at step 408, the mobile device 102 transmits the automated measurement and voice signal to the server 130. As previously illustrated in FIGS. 1 and 2, the mobile device communicates this data over a telecommunication network or computer network in a secure and efficient manner.

As shown in step 410, the server computes a speech therapy assessment from the measurement data and corresponding speech evaluation. The assessment is made in part from the server's own processing of the voice signal but also includes consideration of the features extracted from the mobile device sent to the server. That is, the server 130 additionally performs its own comprehensive analysis of the voice signal received from the mobile device where processing resources are not so limited as on the mobile device. This can include analyzing spatio-temporal speech patterns in the voice signal, comparing the spatio-temporal speech patterns to psychoacoustic models, and generating a speech disorder compensation model according to measured changes in the spatio-temporal speech patterns produced by the comparing. Furthermore, as an example, the server 130 can reference audio files and psychoacoustic models from a database unavailable to the mobile device at the time of voice capture. The server can further perform the steps of mapping the speech features and voice signal to particular registered users, associating the speech signal to a user voice profile of a registered user, collecting subjective user feedback associated with the delivery of the speech therapy technique, and adapting the speech therapy technique in accordance with subjective user feedback corresponding to the user voice profile.

The server upon performing its own assessment, at step 412, by way of the web client 106 responds with a speech therapy technique according to a specified clinical moderation. The specified clinical moderation is provided through the web-client 106 by which interaction with the server 130 can statistically evaluate the automated measurement and voice signal for disorder characteristics, and propose the therapy technique most probabilistically suited to provide the speech feature correction in view of the assessed disorder characteristics. Notably, the clinical moderation can include transmitting the automated measurement to the web client 106, that by way of clinical interaction, remotely monitors and manages delivery and clinical feedback of the therapy technique on the mobile device 106. It is through the web-client that clinical outcomes can be managed and moderated for the use on his or her mobile device 102.

At step 414, the server 130 responsive to a directive from the web-client 106, or by automated scheduling or reporting means, transmits and directs the mobile device 102 to implement the speech therapy technique directly. The speech therapy technique provides speech compensation directives and can implement disorder modification (e.g., stutter correction, temporal cues, etc.) for example, through fluency shaping, by one of synthesizing slowed speech, easy phrasing initiation, gentle voice onset ramping, soft contacting, breath stream management, deliberate flowing between words, monotonic, light articulatory contacts, pre-voice exhalation, diaphragmatic breathing, and continuous phonation.

At step 416, either or both the mobile device and web client individually or in combination can direct speech therapy, which can include voice correction, pronunciation guidance, and speaking practice, but is not limited to these. The signal processing techniques that implement the speech therapy technique include a combinational approach of psychoacoustic analysis and processing performed on the mobile device 102 directly or by way of delivered audio through the server 130. The signal processing as previously noted can include tuning the speech therapy technique to emphasize speech pronunciation parameters previously requiring correction, for example, according to a user's voice profile, and as one example, under previously detected noise conditions.

As will be shown ahead in FIG. 5A, dimensions of perceptual evaluation of voice disorders are calculated and applied to speech therapy implementation on the mobile device. In one embodiment, the method 400, as exemplified in steps 416, maps the speech features and voice signal to particular registered users, associates the speech signal to a user voice profile of one of the registered users, collects subjective user feedback associated with the delivery of the speech therapy technique, and adapts the speech therapy technique in accordance with subjective user feedback associated with the user voice profile. In one arrangement, the mobile device 102 isolates disordered speech and matches parameters associated with its pronunciation within a profile matching module to assess rhythmic disorder in deriving the speech therapy technique.

The mobile device also displays the speech therapy assessment, as shown at step 418, and also by way of the GUI shown in FIG. 3. This assessment and visual display can also be provided to the web-client 106 (and in certain cases managed by the web-client) to permit clinical moderation of the specified therapy technique; for example, how the signal processing is applied to voice signals, and permit the clinician (or provider) to visualize, monitor and audibly evaluate outcome treatment. As shown in FIG. 3, the mobile device exposes a Graphical User Interface (GUI) that interfaces to the server 130 and displays the speech therapy assessment.

The GUI by way of the mobile device 102 provides for speech compensation training on the mobile device in accordance with the speech therapy technique shown in step 420. As part of the speech therapy and compensation training, and as previously discussed and shown in FIG. 3, the user may be presented with a speech therapy GUI that provides the user with training. The GUI can provide speech feature correction to the voice signal (or propose alternative pronunciations), display the speech therapy assessment, and provide for speech compensation training on the mobile device in accordance with the speech therapy technique. Notably, the training experience can be directed back to the web-client 106 to provide clinical feedback and outcome modeling. This information along with the speech therapy (or treatment plan) can be stored with the user's voice profile for continued evaluation and retrieval. As one example, the mobile device amplifies and attenuates voiced sections of speech for fluency shaping, shortens detected silence sections to enhance speech continuity, overlap and adds repeated speech sections to correct stuttering, and adjusts a temporal component of speech onsets to enhance articulation.

Briefly, a communication disorder is in which the flow of speech is broken by repeated syllables or words, prolongations, or abnormal stoppages or ‘blocks’ of sounds and syllables. Stop-gaps are blocks in speech where the user wants to say something but is unable to get it out. Omissions are certain sounds are deleted, often at the ends of words; entire syllables or classes of sounds may be deleted; e.g., ‘fi’ for ‘fish’. Substitutions are where sound is substituted for another, often with similar places or manners or articulation; e.g., fith for fish. Distortions are sounds changed slightly by what may seem like the addition of noise, or a change in voicing; e.g., filsh for fish. Additions are extra sounds added to one already produced correctly; often occurs at the ends of words; may include changes in voicing; e.g., fisha for fish. The GUI delivers the speech therapy technique and training to employ corrective actions associated with these communication disorders.

Notably, as shown in step 422, the web-client, during the delivery of the speech therapy technique and training in real-time or through scheduled intervention monitors, can manage and modify the speech therapy technique through user interaction and feedback. This can include scheduled intervention or one-on-one dialogs between the user and provider in real-time during a speech therapy session or requested user intervention. The web client communicates securely with server via an internet browser, and provides user login, new user registration, and user account capabilities, and provides review of measurement and observation data accessible to registered users and clinicians. When the user is a person in need (PIN) and the clinician is a Speech Language Pathologist (SLP), the web-client can host a PIN therapy management module allowing the SLP to monitor, manage and modify particular therapy techniques for individual PIN, for example, those registered under the SLP, or for PSW individuals granted access to the managed delivery of speech therapy. This information can be new therapy procedures, guidelines, information or one-to-one communication between SLP and PIN, which can be in real-time if both SLP and PIN are connected to at the same time. The PIN profile management can be used by SLP and by individual PIN. This module can be made available to both SLP and PIN to provide audio data captured via the web-client and also the mobile deivce; data which is sent to the server for processing and analysis as previously indicated for measurement and assessment.

FIG. 5A shows a correlation chart 500 between speech features and the six dimensions of perceptual evaluation of voice disorders introduced above, in accordance with one embodiment. As illustrated, the six dimensions are roughness 502, breathiness 504, strain 506, pitch 508, loudness 510 and overall severity 512. A brief overview is provided along with how the calculation of these acoustic measures is performed. It should be noted that these calculations can be performed as part of the voice evaluation and assessment and speech therapy implementation on the mobile device 102 and/or server 130 shown in FIG. 1 and according to the method previously disclosed.

Roughness 502 is noise in the formant region and waveform perturbation, indicated by audible low-frequency noise and measurable irregularities in pitch and amplitude. The harmonics-to-noise (HNR) ratio is a frequency-based perturbation measure that estimates the level of noise in the speech signal and has been shown to have high correlation with roughness. HNR is estimated in the frequency domain as the energy of the spectral peaks that exceeds the noise level at the frequencies of the harmonic peaks. Since it is difficult to obtain the noise level from the spectrum, a technique that is used is to calculate the cepstrum, low pass filtering (liftering) and converting back to the spectral domain. Instead of analyzing the whole noise spectrum, only noise reference levels at the harmonic peak frequencies need to be estimated. The HNR is then the mean difference between the harmonic peaks and the reference levels of noise at these peak frequencies. The relative level of spectral noise corresponds with the perception of an irregular pattern of vocal fold vibration or insufficient vocal fold adduction.

Breathiness 504 is the perception from an incomplete closure of the vocal folds and from posterior glottal opening, causing turbulent flow in the area of glottis. Cepstral peak prominence has been shown to correlate to the severity of breathy voice. The cepstrum is generally defined as the spectrum of the log of the spectrum of the voice signal. The cepstral peak prominence (CPP) it is calculated using a fixed time window on the speech signal when calculating the Fourier Transform. A second Fourier transform is then taken on the log of the squared amplitude of the first spectrum. A signal with a well-defined harmonic structure (normal speech) will show a peak corresponding to the fundamental period. The CPP is the difference (in dB) of this peak and the regression line of the magnitude of the cepstrum over quefrency.

Disordered voices will have a less well-defined harmonic structure resulting in a smaller CPP. Using a fixed window length makes the CPP measure dependent on the fundamental frequency of speech. This can be a problem when using the same algorithm on a wide range of fundamental frequencies which would be the case when working with children and adults.

Strain 506 is the perception associated with increased and poorly regulated laryngeal muscle tension. Spectral slope measures have shown to have correlation in predicting the strain in the speech signal [38]. Spectral slope is the relative amount of energy in low versus high frequency regions of the speech spectrum and it can be calculated from vowels and from continuous speech. The energy in the spectrum above and below 1 kHz or another frequency is calculated over time. Increased energy in high frequency regions corresponds to breathy voices while decreased energy corresponds to strained voicing. Other frequencies correspond to breathiness. Spectral slope algorithms will be examined to determine good correlations to voice disorder measures and other algorithms will be investigated for higher correlation.

Pitch 508 is the perception associated the fundamental frequency of voicing which is the rate of vibration of the vocal folds and the number of vocal fold openings per second. For a periodic signal like voiced speech the fundamental frequency is the lowest frequency component of the complex sound wave and it can be computed using the position of the autocorrelation function of the speech sound. The jitter is a measure of the short term variation of the fundamental frequency, and shimmer is a measure of the short-term variation in the amplitude of the fundamental frequency waveform. All three of these provide some measures related to perpetual scoring of pitch. Pitch is not too constant and in disorder speech it varies a lot. We will compute various factors of pitch and carry out factor analysis to select with factor has the highest correlations and use those in the final implementation

Loudness 510 is a perceptual measure of sound (e.g., spoken level) and is generally measured in sone units. Louder phonation requires higher subglottal pressure as it is an emphasis of the articulation in sounding words. Coordination between the laryngeal muscles and breathing muscles is necessary in order to stabilize the relationship between pitch and loudness. The loudness of the voice is the amplitude or sound pressure level (SPL) and can be measured in decibels (dB). It can be converted to a loudness level according to the Moore, Glasberg & Baer method of calculating loudness from the spectrum of a sound.

Overall severity 512 of voice disorder can be reliably measured using various spectral signal processing techniques or related feature extraction programs. For example, a first cepstral peak also called first rahmonic R1 can reliably measure voice disorder characteristcs. R1 is pitch-independent when the fundamental frequency of the speech is known. To compute R1, a first Fourier transform is calculated with a pitch-period-dependent window then the inverse Fourier transform log power spectrum is computed; a peak-picking algorithm finds R1 as the maximum amplitude (in dB) near the expected pitch.

FIG. 5B illustrates a table of speech features measured herein in accordance with various embodiments. For example, either the mobile device 102 or the server 130 can include an assessment module to measure speech features and depending on processing power, time and complexity can capture and measure the following list of features: speech recording, speech transcription, stutter detection and classificaton, speaking rate, frequency and amount of voicing, average magnitude profile, prolongatins, repetitins, blocks, stop-gaps, average length of block, intensity of speech, cepstral distance, energy distance, phoneme distance, omissions, substitutions, distortions and additions.

The assessment module provides this multidimensional assessment and treatment approach to a PIN, which form a basis of assessment and treatment planning. The affective component includes thoughts, emotions, and attitudes that accompany stuttering and communication in general; this is captured through subjective questionnaires as collected in the feedback stage of method 400. A great deal of emphasis is placed on having the PIN manage negative feelings, attitudes and emotional reactions to stuttering. The linguistic component is related to the PIN s language skills and abilities that impact the frequency of stuttering, this is measured using the speech processing algorithms described in earlier tasks. The motor component is associated with a number of factors that influence stuttering such as the frequency, type, duration, and severity of stuttering as well as the presence of secondary coping behaviors and overall speech motor control that is associated with stuttering, this is measured using the speech processing algorithms described in earlier tasks. The social component of communication involves a client's communicative competence relative to reactions the PIN has to various communicative partners in a variety of speaking situations. This is delivered by having PIN use it under different speaking situations and uses the measurement algorithms for analysis. Thus the system and method combines multidimensional assessment via novel speech processing.

The majority of stuttering therapy provided by way of the methods and devices herein described falls into two categories, (1) fluency shaping and (2) stutter modification. The stuttering modification makes the person's stuttering easier and less severe, to reduce the fear of stuttering and to eliminate avoidance behaviors associated with speaking and stuttering. The fluency shaping therapy herein provided re-trains the speaking mechanism by teaching the PIN to control his or her breathing phonation and articulation. The system and method herein described and contemplated delivers both types of therapy and can be actively modified to accommodate the styles of the therapist and PIN. Other techniques are delivered with “speaking assignments” that are evaluated using the subjective questionnaire.

The subjective feedback, for example, which includes the subjective questionnaire, supports three types of operating environments: (1) live mode: when PIN is engaged in a normal everyday conversation, (2) training mode: when the PIN is practicing therapy techniques through a training session on the smartphone, and (3) offline mode: when the PWS submits data for analysis and review by SLP. It supports corresponding three types of signal processing: (1) real-time processing: used during live mode, (2) non-real-time processing: used during training mode, and (3) offline processing: is carried out on the server during the offline mode. Standard evidence based clinical therapy techniques will be delivered using the system and method described; they will be tweaked by SLPs for delivery over a mobile platform in an out of the clinic setting.

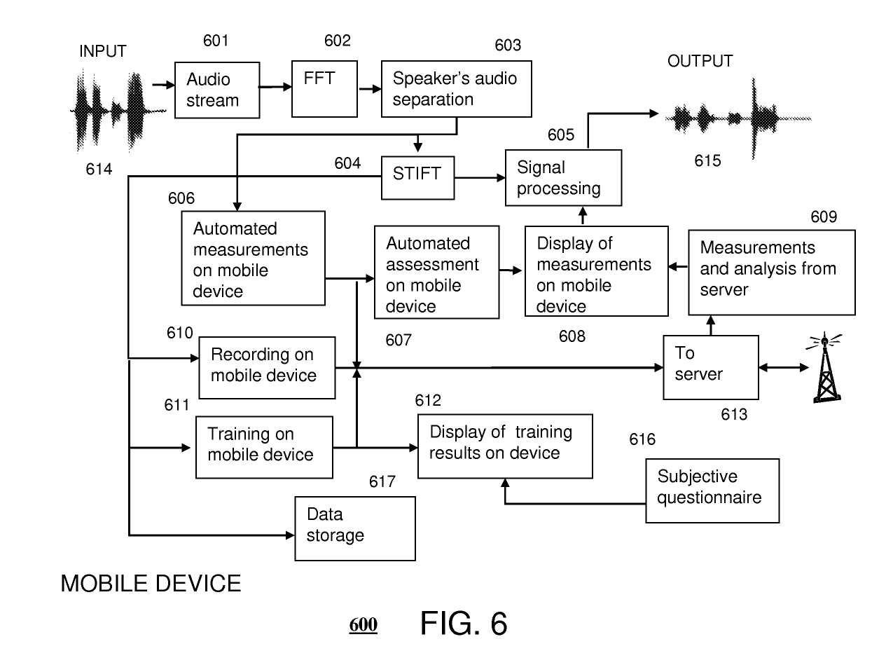

FIG. 6 diagrammatically illustrates a means of implementing speech therapy on a mobile device in accordance in accordance with one embodiment. Briefly, the mobile device platform 102 can be any smart processing platform with digital signal processing capabilities, application processor, data storage, display, input modality like touch-screen or keypad, microphones, speaker, Bluetooth, and connection to the internet via WAN, Wi-Fi, Ethernet or USB. This embodies smartphone, iPad and iPod type devices.

Therapy Techniques provided on the mobile device 102 broadly include but is not limited to Stutter Modification and Fluency Shaping. Stutter modification includes (but is not limited to) freezing, voluntary stuttering, cancellation, pull out and preparatory set. Fluency shaping includes (but is not limited to) slowed speech, easy phrase initiation/gentle voice onset, soft contact, breath stream management, deliberate flow between words, monotone, light articulatory contacts, pre-voice exhalation, diaphragmatic breathing, continuous phonation.

As illustrated, 614 is the PIN speech while they are having normal conversation during everyday situations or during particular training sessions on 600. 601 is the audio stream captured via microphones on the mobile platform or via paired Bluetooth headset or wired headsets. 602 is the Fast Fourier transform and associated novel feature extraction to achieve noise robust behavior. 603 is a method to isolate only the user's speech from the audio signal. 604 is the inverse Fast Fourier transform to recreate the original speech signal. 605 is signal processing block that processes the speech before playing played back to the user. 615 is the speech signal that is played back to user. 606 are the automated measurements of speaking rate, amount of voicing, average magnitude profile, intensity of speech (loudness), pronunciation\speech correction modules developed on 600.

The exemplary embodiments uses measuring changes in speech parameters for speaking rate, spectral analysis for voicing, and statistical modeling for pronunciation/speech correction. 607 is the automated assessment of the 606 based on any number of clinical speech therapy technique desired by SLP. 608 is the real-time and off-line display of the assessment allowing a PIN to manage and maintain their fluency, also allowing them to follow fluency techniques recommended by their SLP. 609 are the measurements and assessments provided by the server based on the speech signal that was transmitted to server for analysis. 610 is the real-time recording of only the PIN speech. 611 is novel training and practice module on 600, allowing PIN to practice desired fluency techniques. 612 is the display method of providing an interactive display for carrying out training and practice. 613 is the method and system that transmits user's speech data to the server for more in-depth analysis of the speech signal.

The module 616 is the subjective questionnaire filled by PIN on 600 to keep a track of progress by capturing associated behavioral, subjective details, avoidance behaviors, and situation details. 617 is the secure data storage on 600 that is used for storing 606, 607, 609, 610, 611, 616 and necessary models for 602 and 603. In another arrangement, the mobile device can perform a weighted multiplication to the original FFT signal followed by novel psychoacoustics models for source separation, noise removal, end-point detection and then continue with IFFT, thereby maintaining a true fidelity of the PIN speech signal to the maximum extent possible.

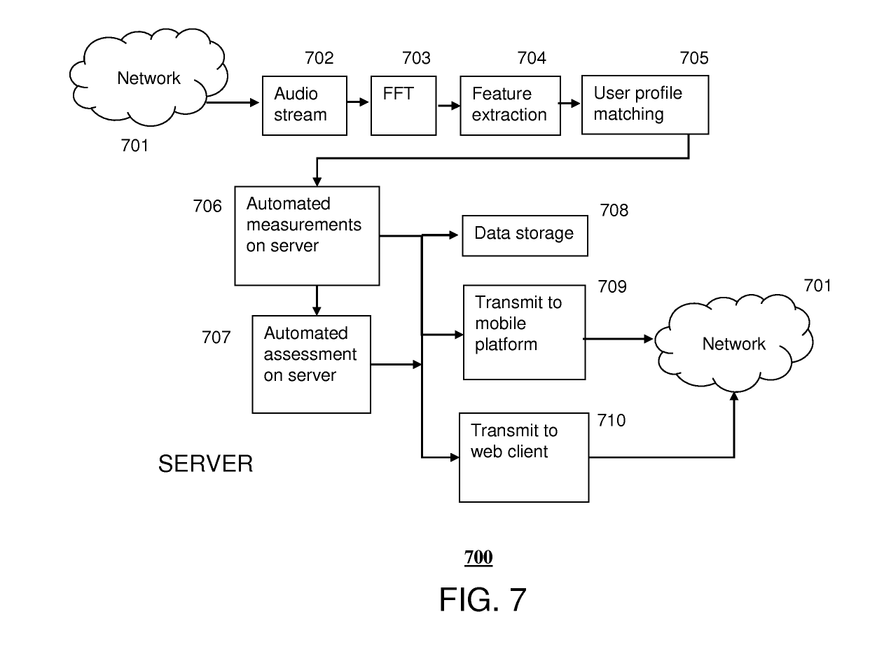

FIG. 7 diagrammatically illustrates a means of implementing speech therapy by way of a server in accordance in accordance with one embodiment. Briefly, the server 130 can be a web-server providing digital signal processing capabilities, an application processor, data storage, display, an input modality, and connection to the internet. This embodies server hardware and software systems running Windows, Linux, Unix, or other operating systems.

As illustrated, module 701 is the internet cloud through which the server communicates securely with various mobile platforms (600). 702 is the audio stream received from 600. 703 is the Fast Fourier Transform, 704 is the novel feature extraction module that encompasses psychoacoustic algorithms for calculating noise robust features. 705 is the profile matching module that maps the received audio data 702 to particular registered users and associates the data with their profile. 706 are the automated measurements of dysfluency count not limited to stop-gaps, repetitions, prolongations, mean-duration of largest block. This will be achieved using (but is not limited to) signal processing algorithms/techniques including statistical modeling and pattern recognition. 706 also contains speaking rate, amount of voicing and average magnitude profile, intensity of speech and emotion detection, developed on 700.

Module 707 is the automated assessment of the 706 based on any number of clinical speech therapy techniques desired by SLP. 708 is the secure data storage on 700 that is used for storing 705, 706, 707, and necessary models for 703 and 704. 709 is the module for transmitting 706 and 707 back to particular mobile platform 600 based on current profile provided by 705. 710 is the module for transmitting 706 and 707 to particular web-client 800 based on current profile provided by 705. In another arrangement, the server implements a method of speech dysfluency measures that permits autonomous operation and provides for clinical therapy outside of clinics, that today is done by a SLP in their clinics.

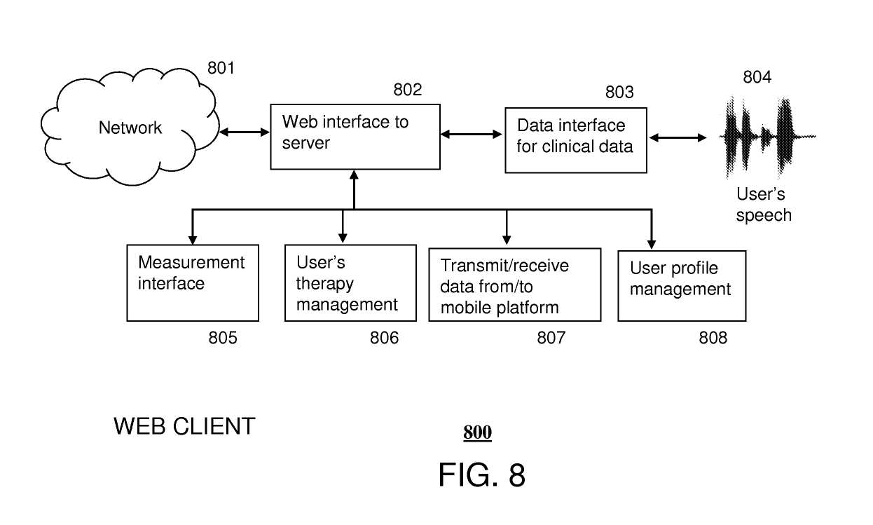

FIG. 8 diagrammatically illustrates a means of implementing speech therapy by way of a web-client in accordance in accordance with one embodiment. Briefly, the web-client 106 can run on any conventional browser. The browser can run on a personal computer, laptop, or mobile device that has digital signal processing capabilities, an application processor, display, input modality, and connection to the internet. The internet connectivity provided by the network 120 can communicate over conventional secure Hypertext Transfer Protocol (Internet protocol), HTTP, TCP/IP and other network protocols, including Session Initiated Protocol (SIP), but is not limited to any of these.

As illustrated, module 801 is the internet cloud through with the web-client communicates securely with server (700). 802 is the user interface of the web-client provided via an internet browser. It provides user login, new user registration, and user account capabilities. 805 is the user interface to review the measurement data from any of the multiple real-life situations. This can be accessed by a SLP for all the PIN registered under him or by an individual PIN to review their own data. 806 is the PIN therapy management module allowing a SLP to monitor, manage and modify particular therapy techniques for individual PIN.

Module 807 is for interacting with the mobile platform 600 and for updating information on 600. This information can be new therapy procedures, guidelines, information or one-to-one communication between SLP and PIN, which can be in real-time if both SLP and PIN are connected to 801 at the same time. 808 is the PIN profile management that can be used by SLP and by individual PIN. 803 is a module available for SLP to provide audio data captured in their clinics, this can be via a recorded sample. 804 is the speech signal collected in the clinic.

In another arrangement, the web-client implements a method to allow easy access to the SLP and PIN to review the data gathered from real-life situations, to monitor, to access and provide speech therapy. The exemplary embodiments allow for access from anywhere via a standard web-browser without having the constraints of running on a particular personal computer.

It will be apparent to those skilled in the art that various modifications may be made in the present invention, without departing from the spirit or scope of the invention. Thus, it is intended that the present invention cover the modifications and variations of this invention provided they come within the scope of the method and system described and their equivalents.

As one example, alternate embodiments provide methods of automated measurement, and assessment of stutter on the mobile platform that permits for autonomous operation in real-life situations for clinical therapy outside of clinics. As yet another example, the methods disclosed herein can be modified to provide training and practice on the mobile platform to permit autonomous operation in real-life situations and provide for clinical therapy outside of clinics, that today is done by an SLP in their clinics.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for providing speech therapy, the method comprising:
on a mobile device,
capturing a voice signal;
extracting speech features from the voice signal;
performing an automated measurement of the speech features and the voice signal;
transmitting the automated measurement and voice signal from the mobile device to
a server communicatively coupled to a web-client to
compute a speech therapy assessment from that data,
respond with a speech therapy technique according to a specified clinical moderation, and
manage and implement the speech therapy technique and training on the mobile device.

2. The method of claim 1, wherein the specified clinical moderation
statistically evaluates the automated measurement and voice signal for disorder characteristics; and
proposes the therapy technique most probabilistically suited to provide the speech feature correction in view of the disorder characteristics.

3. The method of claim 1, further comprising transmitting the automated measurement to the web client that by way of clinical interaction that remotely monitors and manages delivery and clinical feedback of the therapy technique on the mobile device.

4. The method of claim 3, wherein the web-client communicates securely with server via an internet browser, and provides user login, new user registration, and user account capabilities, and provides review of measurement and observation data accessible to registered users and clinicians.

5. The method of claim 1, further comprising the steps of:
analyzing spatio-temporal speech patterns in the voice signal;
comparing the spatio-temporal speech patterns to psychoacoustic models; and
generating a speech disorder compensation model according to measured changes in the spatio-temporal speech patterns produced by the comparing.

6. The method of claim 1, further comprising the steps of:
mapping the speech features and voice signal to particular registered users;
associating the speech signal to a user voice profile of a registered user;
collecting subjective user feedback associated with the delivery of the speech therapy technique; and
adapting the speech therapy technique in accordance with subjective user feedback corresponding to the user voice profile.

7. The method of claim 1, wherein the speech features comprise speaking rate, voicing, magnitude profile, intensity and loudness, pitch, pitch strength, and phonemes.

8. The method of claim 1, wherein the automated measurements comprise stop-gaps, repetitions, prolongations, onsets, and mean-duration.

9. The method of claim 1, wherein the automated assessment comprises measuring changes in speaking rate, spectral analysis for voicing, and statistical modeling for determining pronunciation, accent, articulation, breathiness, strain, and applying speech correction.

10. The method of claim 9, further comprising tuning the speech therapy technique to emphasize speech pronunciation parameters previously requiring correction according to a user's voice profile under similar noise conditions.

11. The method of claim 1, wherein the speech therapy technique provides disorder modification through fluency shaping by one of synthesizing slowed speech, easy phrasing initiation, gentle voice onset ramping, soft contacting, breath stream management, deliberate flowing between words, monotonic, light articulatory contacts, pre-voice exhalation, diaphragmatic breathing, and continuous phonation.

12. A mobile device client, comprising
a processor to capture and record from one or more microphones a voice signal, extract speech features from the voice signal, perform an automated measurement of the speech features and the voice signal, and perform automated assessment from that data to respond with a analysis feedback for the user
a memory to temporarily store the speech features, voice signal, automated measurement and automated assessment; and
a communications unit to transmit the automated measurement and voice signal from the mobile device to a server that computes a speech therapy assessment from that data, responds with a speech therapy technique according to a specified clinical moderation, and transmits and implements the speech therapy technique on the mobile device,
wherein the mobile device thereafter provides speech feature correction to the voice signal, displays the speech therapy assessment, and provides for speech compensation training on the mobile device in accordance with the speech therapy technique.

13. The mobile device of claim 12, wherein the processor is a digital signal processor that
analyzes spatio-temporal speech patterns in the voice signal by way of spectral decomposition and reconstructive Fourier transforms;
compares the spatio-temporal speech patterns to psychoacoustic models saved in the memory; and
produces a speech disorder compensation weighting that is applied to the spectral decomposition to enhance pronunciation upon the reconstructive Fourier transforms.

14. The mobile device of claim 12, comprising a mobile device Graphical User Interface (GUI) that interfaces to the server and displays the speech therapy assessment, and provides for speech compensation training on the mobile device in accordance with the speech therapy technique

15. The mobile device of claim 12, wherein the processor
amplifies and attenuates voiced sections of speech for fluency shaping;
shortens detected silence sections to enhance speech continuity;
overlap and adds repeated speech sections to correct stuttering; and
adjusts a temporal component of speech onsets to enhance articulation.

16. A system for providing speech therapy, comprising:
a mobile device including:
a processor to capture and record from one or more microphones a voice signal, extract speech features from the voice signal, perform an automated measurement of the speech features and the voice signal, and perform automated assessment from that data to respond with a analysis feedback for the user;
a memory to temporarily store the speech features and voice signal and automated measurement; and
a communications unit to transmit the automated measurement and voice signal from the mobile device, and
a server communicatively coupled to a web-client to
compute a speech therapy assessment from the automated measurement and voice signal received from the mobile device,
respond with a speech therapy technique according to specified clinical instructions, and
transmits and manages an implementation and outcome of the speech therapy technique by way of the mobile device.

17. The system of claim 16, wherein the mobile device
provides speech feature correction to the voice signal,
displays the speech therapy assessment, and
provides for speech compensation training on the mobile device in accordance with the speech therapy technique.

18. The system of claim 16, wherein the server or mobile device
perform source separation, noise removal, and end-point detection on the voice signal according to psychoacoustic models to produce isolated features;
apply disorder modifications on the voice signal that include freezing, stuttering, cancellation, pull out and preparatory set in view of the isolated features.

19. The system of claim 16, wherein the server or mobile device
maps the speech features and voice signal to particular registered users;
associates the speech signal to a user voice profile of one of the registered users;
collects subjective user feedback associated with the delivery of the speech therapy technique; and
adapts the speech therapy technique in accordance with subjective user feedback associated with the user voice profile.

20. The system of claim 16, wherein the mobile device isolates disordered speech and matches parameters associated with its pronunciation within a profile matching module to assess rhythmic disorder in deriving the speech therapy technique.
